(19) United States
(12) Patent Application Publication
(10) Pub. No.: US 2026/0161677 A1
(43) Pub. Date: Jun. 11, 2026

(54) SELECTIVELY USING RETRIEVAL AUGMENTED GENERATION FOR GENERATIVE MODEL PROMPTING

(71) Applicant: GOOGLE LLC, Mountain View, CA (US)

(72) Inventors: Carsten Isert, Zurich (CH); Patrick Andreas Zoechbauer, Zurich (CH)

(21) Appl. No.: 18/972,207

(22) Filed: Dec. 6, 2024

(51) Int. Cl. G06F 16/3329; G06F 16/338

(52) U.S. Cl. CPC G06F 16/3329; G06F 16/338

(57) ABSTRACT

Implementations are described herein for selectively using retrieval augmented generation (RAG) for generative model prompting. In various implementations, a generative model query of a user may be analyzed to determine whether retrieval augmented generation (RAG) should be used to generate a response. If RAG should be used, a generative model input prompt may be formed with data indicative of the generative model query and data indicative of: (i) user-specific conditioning data (USCD) associated with the user, or (ii) personal RAG data of the user. The user-specific conditioning data may have been built over time based at least in part on the personal RAG data of the user. The prompt may be processed using generative model(s) to generate generative model output, conditioned on one or both of the USCD or the personal RAG data of the user, that includes a response to the generative model query.

### BACKGROUND

Generative models such as single-modal or multi-modal large language models (LLMs) (e.g., vision language models or “VLMs”) can be used to process sequences of input tokens to generate sequences of output tokens. Generative models are applicable across a wide range of tasks. For example, generative models are increasingly being used to power automated assistants (also referred to as “virtual assistants” or “chatbots”), which enable humans (which are referred to as “users” when interacting with automated assistants) to participate in natural language dialogs with automated assistants. Some generative models that are pretrained/trained using web-scale data are referred to as “foundation” models.

### SUMMARY

When users engage with automated assistants, they may expect the automated assistants to “learn” from interactions with the user so that the automated assistants become increasingly personalized (or “bespoke”). For example, a vegetarian user may expect his or her automated assistant to learn—from an explicit input by the user and/or from observing various interaction(s) between the user and computing device(s) over time—that the user does not wish to receive restaurant recommendations for establishments with few or no vegetarian options.

As another example, users often use automated assistants to control smart appliances such as lights, thermostats, locks, media playback devices, etc. Those users may expect that as they make changes to their smart appliances—whether it be commissioning new appliances, altering existing appliances, or decommissioning existing appliances—the automated assistant will be made aware of those changes and respond to future requests appropriately. For example, if a user adds a smart light to a kitchen, the user may expect that future invocations of “turn on all the kitchen lights” will cause the new smart light to be turned on, too.

Some automated assistants may be personalized by building and maintaining a personalized user data structure, e.g., in the form of one or more database tables, a personalized knowledge graph, etc. Such a personalized user data structure may be updated manually by the user and/or automatically, e.g., when the user alters a smart appliance configuration, accepts or rejects a recommendation (e.g., of digital content, restaurant, etc.), engages in patterns of behavior (e.g., repeatedly eating the same type of cuisine), etc. However, conventional automated assistants may access personalized user data structures programmatically and/or using predefined actions, which can become unwieldy as the personalized data structure grows with increasingly heterogeneous data (e.g., emails, text messages, various user interactions with computing devices, etc.).

Implementations described herein relate to building and maintaining “user-specific conditioning data” (USCD) in association with individual users, as well as using USCD in conjunction with generative artificial intelligence (AI) to generate content that is tailored to individual users. The USCD may be built and/or maintained by accumulating data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), individuals submitting search queries and/or consuming content responsive to search queries, individuals' browsing data, individual engagement with social media, individual engagement with generative models (including any modality of data provided by the individual to the generative model, or generated using the generative model), individuals' consumption of documents and/or media (e.g., images, videos, games, podcasts, music, etc.), individuals' engagement with mapping applications (including accumulated locations, saves places, etc.), device and/or application configuration (e.g., applications installed on a mobile device, integration between applications, mobile device settings, etc.), data derived from documents created and/or edited using productivity software (e.g., word processing documents, spreadsheets, presentations), task lists, shopping lists, chats (e.g., SMS, MMS), reviews the individuals have posted (e.g., about restaurants, recipes, products), photos (including captions and/or detailed summaries of photos generated using generative models such as VLMs), payments made and/or received by individuals (including comments or metadata provided with those payments), third party software, personal uniform resource locators (URLs), and so forth.

While many examples described herein related to users interacting with generative model-powered automated assistants, this is not meant to be limiting. Techniques described herein are applicable outside of the automated assistant context. For example, techniques described herein may enable users of AI-powered productivity software, such as word processors, spreadsheets, presentation programs, etc., to have increasingly bespoke experiences. As another example, users engaging with a general-purpose generative model interaction interface (e.g., not specifically an automated assistant) such as might be provided via a web browser may benefit from techniques described herein.

As yet another example, an integrated development environment (IDE) or other application in which source code can be created/edited may include a generative AI assistant configured with selected aspects of the present disclosure. As yet another example, a robot that can be controlled using natural language may benefit from techniques described herein. Conditioning the robot's behavior on the individual's attributes and/or context represented by the individual's USCD may cause the robot to behave in a manner that is not only responsive to the individual's explicit command, but also is aware of the individual's personal preferences, context, attributes, etc. For example, if the individual asks the robot, “can you get me something to drink,” an underlying world model (implemented as a generative model) of the robot may be able to ascertain the individual's personal preferences and bring back a beverage that the individual is more likely to enjoy.

Techniques described herein may give rise to various technical advantages. For example, techniques described herein may leverage new user interactions between a user and a client device to update a user's USCD, such as by adding new user attributes that, if accounted for when the individual engages with generative AI, would benefit the user's experience by making responses more useful and/or tailored to a user's specific situation. This in turn may decrease the interaction required, thereby reducing the use of computational resources such as memory and processor cycles.

Techniques described herein may also enable generative model input prompts (or context) to be shortened because the raw data that is used to formulate USCD may be compressed in various ways, such that the resulting USCD is more concise than the underlying raw data, or than what a user may provide as a manual prompt. For example, natural language describing aspects or attributes of a user, such as electronic correspondence, consumed documents, database tables, etc., may be condensed using techniques such as generative model-based textual summarization prior to being assembled into the USCD. Additionally or alternatively, the USCD could be formulated as reduced-dimensionality, semantically-rich embedding(s) that can be represented using far fewer input tokens than, for instance, natural language, database tables, logs of user queries, emails or other electronic correspondence in native formats, etc. Having concise USCD may decrease—potentially to a significant degree—the amount of calculations required to process the input prompts, thereby decreasing computational cost/load and/or latency experienced by the user.

Techniques for selectively accessing personal retrieval augmented generation (RAG) data described herein may provide additional advantages. It may not be feasible or advisable to include multimodal and/or high dimensionality data such as images, videos, audio, etc., in an individual's USCD, as that could increase the size of the USCD and, consequently, computational costs and/or latency. It also may be challenging to distill the most relevant and/or useful information from these data sources into USCD, e.g., because that may require significant computational resources (e.g., textually summarizing a video can be resource-intensive and may yield at least some data of limited relevance). However, by making personal RAG data available to augment USCD as described herein, it is possible to quickly retrieve the most relevant personal RAG data on demand.

### BRIEF DESCRIPTION OF THE DRAWINGS

FIG. 1 is a block diagram of an example environment in which implementations disclosed herein may be implemented.

FIG. 2 schematically depicts an example of how various components of FIG. 1 may cooperate to conduct selected aspects of the present disclosure.

FIG. 3 illustrates an example of how a RAG analysis input prompt can be assembled according to implementations disclosed herein and further illustrates an example of how a generative model input prompt can be assembled according to implementations disclosed herein.

FIG. 4 schematically depicts an example of how USCD associated with an individual may be used, alone and/or in combination with personal RAG data, to practice selected aspects of the present disclosure.

FIG. 5 illustrates a flowchart demonstrating an example method for practicing selected aspects of the present disclosure.

FIG. 6 illustrates an example architecture of a computing device.

### DETAILED DESCRIPTION

Implementations described herein relate to building and maintaining “user-specific conditioning data” in association with individual users, as well as using user-specific conditioning data in conjunction with generative artificial intelligence (AI) to generate content that is tailored to individual users. User-specific conditioning data (often abbreviated herein to “USCD”) may be built and/or maintained by accumulating and/or monitoring data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), users submitting search queries and/or consuming content responsive to search queries, user engagement with social media, users creating and/or consuming documents, and so forth. USCD itself may be expressed in various forms, such as a textual description/summary of the individual's attributes, tokens/embeddings encoding the individual's attributes, images and/or other modalities that convey the individual's attributes, or any combination thereof. In other implementations, all or part of the USCD could be implemented as a machine learning model such as a generative model that is fine-tuned based on user interactions of the individual.

More specifically, but not exclusively, implementations disclosed herein are directed to causing a generative model query of a user to be analyzed to determine whether retrieval augmented generation (RAG) should be used. In response to a determination that RAG should be used, data indicative of the generative model query, user-specific conditioning data (USCD) associated with the user, and/or selected personal RAG data of the user are retrieved and/or caused to be assembled into a generative model input prompt. The USCD may have been built over time based at least in part on the personal RAG data. The generative model input prompt is caused to be processed using one or more generative models to generate generative model output that is conditioned on the USCD or the personal RAG data.

Implementations disclosed herein can mitigate (e.g., eliminate) various drawbacks with current techniques that do not leverage RAG. For example, by incorporating a user's interaction history from various sources of user interactions into a USCD summary that is used to condition generative model(s), the system avoids providing information that is irrelevant or conflicts with the individual's own attributes or preferences. As another example, the continuous asynchronous updates of the USCD ensure that the model always has access to the latest relevant information, preventing outdated or irrelevant responses. As another example, the ability to selectively incorporate personal RAG data based on an initial model pass optimizes resource utilization and ensures that only necessary data is included in the prompt, thus improving efficiency and reducing latency.

As a non-limiting example of some implementations disclosed herein, consider a user, John Doe, who frequently uses a generative model-powered automated assistant on his smartphone. Over time, the system has built a USCD for John Doe, e.g., a several-thousand-token summary of his interactions, including the general notion that he has an upcoming trip to San Francisco Monday-Thursday of the following week, his expressed interest in cooking and WWII movies, and his profession as a programmer at FakeCompany. John asks the assistant, “What's my schedule next week?” The system analyzes this query and determines that RAG is unnecessary, as the USCD contains sufficient information. The assistant responds with John's San Francisco trip dates. Later, John asks, “What's the flight number for my return?” This time, the system determines that RAG is needed, because the flight details are only in his emails, not summarized in the USCD. The assistant accesses John's emails as part of the RAG process, extracts the flight information, and responds with the correct flight number and arrival time by processing this additional RAG information with his last query.

Personal Retrieval Augmented Generation (RAG) data, encompassing a user's diverse interactions with various online resources, documents, communications, etc., can accumulate to a massive scale. This may necessitate retrieval techniques that are more efficient than simply incorporating all of the individual's personal RAG data into a generative model input prompt. Implementations described herein may leverage a user's USCD, a concise summary of their data, to guide the selective retrieval of only the relevant portions of their personal RAG data. For instance, an initial generative model pass using the user's query and USCD can identify (e.g., using mappings described herein) specific data points within the user's personal RAG data that are most likely to contribute to a comprehensive and accurate response to the user's query, thus avoiding the processing of unnecessary data. In addition to or instead of retrieval instructions that directly access the relevant RAG data based on mappings from USCD, in some implementations, a “fuzzy” or semantic similarity search may be performed, e.g., by comparing embeddings using techniques such as cosine similarity, Euclidean distance, Manhattan distance, Jaccard similarity, etc.

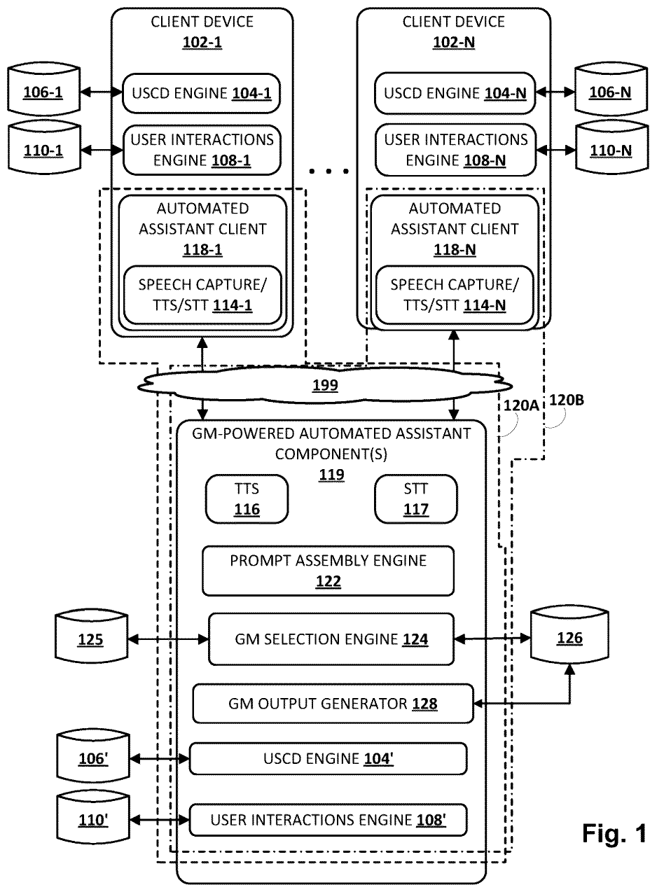

Now turning to FIG. 1, an example environment in which techniques disclosed herein may be implemented is illustrated. The example environment includes a plurality of client computing devices 102-1 to 102-N. Each client device 102 may execute a respective instance of an automated assistant client 118. One or more GM-powered automated assistant components 119 may be implemented on one or more computing systems/servers (collectively referred to as a “cloud” computing system) that are communicatively coupled to client devices 102-1 to 102-N via one or more local and/or wide area networks (e.g., the Internet) indicated generally at 199. Moreover, one or more GM-powered automated assistant components 119 might alternatively be implemented at one or more of client devices 102.

An instance of an automated assistant client 118, by way of its interactions with one or more GM-powered automated assistant components 119, may form what appears to be, from the user's perspective, a logical instance of an automated assistant 120 with which the user may engage in a human-to-computer dialog. Two instances of such an automated assistant 120A, 120B are depicted in FIG. 1 in dashed line. It thus should be understood that each user that engages with an automated assistant client 118 executing on a client device 102 may, in effect, engage with his or her own logical instance of an automated assistant 120. For the sake of brevity and simplicity, the term “automated assistant” as used herein as “serving” a particular user will refer to the combination of an automated assistant client 118 executing on a client device 102 operated by the user and one or more GM-powered automated assistant components 119. It should also be understood that in many cases, automated assistant 120 may respond to a request from any user regardless of whether the user is actually “served” by that particular instance of automated assistant 120.

The client devices 102 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device), a robot, etc. Additional and/or alternative client computing devices may be provided.

In various implementations, an individual communicates with automated assistant 120 utilizing any one of a plurality of client computing devices that collectively form a coordinated ecosystem of client computing devices. In some cases, the coordinated ecosystem of client devices may be linked to the individual via a user profile of the individual that is associated with, for example, the individual's email address. In some such implementations, the individual's user-specific conditioning data (USCD) may also be linked with this same profile, so that that the individual's USCD may be used when the individual operates any client device of their coordinated ecosystem to interact with automated assistant 120, or more generally, to interact with generative model(s).

Automated assistant 120 engages in human-to-computer dialog sessions with a user via user interface input and output devices of one or more client devices 102-1 to 102-N. To preserve user privacy and/or to conserve resources, in many situations a user must explicitly invoke the automated assistant 120 before the automated assistant will fully process a spoken utterance. The explicit invocation of the automated assistant 120 can occur in response to certain user interface input received at the client devices 102. For example, user interface inputs that can invoke the automated assistant 120 via the client devices 102 can optionally include actuations of a hardware and/or virtual button of the client device 102. In some implementations, the automated assistant client may include a component 114 that is configured to capture the user's utterance and either convert it to text using text to speech (TTS) processing, or in some cases, convert the audio directly into semantically rich embeddings, e.g., using an end-to-end transformer-based architecture (with text being generated, if at all, as a byproduct). The component 114 may also include speech to text (STT) functionality for converting text (or embeddings) to synthetic speech or other synthetic audio. For example, textual content received from GM-powered automated assistant components 119 may be processed using the STT functionality of component 114 and output as audio content using one or more speakers.

Client devices 102-1 to 102-N may also include user-specific conditioning data (USCD) engines 104-1 to 104-N and user interactions engines 108-1 to 108-N that are operably coupled, directly or indirectly, with user-specific conditioning (USCD) databases 106-1 to 106-N and user interactions databases 110-1 to 110-N, respectively. Additionally or alternatively, in some implementations, cloud-based instances of these components may be provided. For instance, there may be a cloud-based USCD engine 104′, a cloud-based USCD database 106′, a cloud-based user interactions engine 108′, and/or a cloud-based user interactions database 110′. Anytime any of the reference numerals 104 to 110 are used herein without any additional context (e.g., “−1” or a single quote), that may refer to either the local instance (e.g., 104-1, 106-1, 108-1, 110-1) or the cloud-based instance (e.g., 104, 106, 108, 110).

USCD engine 104 may be configured to build and/or maintain USCD for each user based on data received from user interactions engine 108 and/or from other sources, such as automated assistant client 118. USCD may be indicative of a wide variety of an individual's attributes, including but not limited to preferences, observed behavior, content of electronic correspondence, smart appliance configurations, user-centric coordinated ecosystems of computing devices, schedules, travel history and/or any combination thereof. As noted elsewhere herein, individuals may have complete control over which user interactions (and hence, which of their attributes) are incorporated into their USCD, and which user interactions are not.

USCD engine 104 may store USCD in USCD database 106 in various forms and/or modalities, such as natural language text, structured text such as extensible markup language (XML) or JavaScript Object Notation (JSON), semantically-rich embeddings/tokens, images, videos, and/or any combination thereof. In various implementations, USCD engine 104 may represent user interactions in USCD in different ways. For example, USCD engine 104 may incorporate data indicative of new user interactions into USCD in raw form, whereas previous user interactions may be summarized in the USCD as text/embeddings. In some instances, those new user interactions may be subsequently summarized into text/embeddings when convenient/during downtime. In some implementations, USCD engine 104 or other components herein may formulate USCD to be condensed relative to raw data from which it is derived. For instance, electronic correspondence and/or textual documents consumed by an individual may be summarized using generative model(s) into abridged textual summaries and/or encoded into reduced-dimensionality embedding(s) before being stored as USCD in database 106.

In some implementations, USCD stored in USCD database 106 may be associated with various metadata. This metadata may include, for instance, mappings between portions of the USCD and the underlying user interactions (e.g., raw data) that spawned those portions of the USCD, which are described elsewhere herein. Additionally or alternatively, in some implementations, the metadata associated with USCD may include timestamps of when, for instance, those portions were added to the USCD or last modified. In some instances, these timestamps may be used as mappings between portion(s) of the USCD and an underlying user interactions timeline that is stored, for instance, in user interactions database 110. The USCD metadata may additionally or alternatively include confidence measures associated with individual pieces of data. For instance, a search engine query seeking vegetarian restaurants may be assigned less confidence than an explicit statement from an individual that he or she is a vegetarian. This may be because, for instance, the search engine query is capable of multiple interpretations, such as the individual was seeking a restaurant for a vegetarian friend or colleague. The explicit statement is less ambiguous, and therefore may be assigned a greater confidence measure.

In many implementations, USCD engine 104 may be required to solicit explicit and/or implicit permission from individuals prior to storing data received from user interactions engine 108 as part of USCD in USCD database 106. For example, USCD engine 104-1 may cause client device 102-1 to audibly and/or visually prompt the individual to expressly indicate their willingness to have data provided as USCD by USCD engine 104 and/or user interactions engine 108 be stored by USCD engine 104 in USCD database 106. By opting into such use of their personal data, the individual's privacy and/or security in using such data is maintained. Additionally or alternatively, in some implementations, an individual's USCD may be encrypted before being transmitted to GM-powered automated assistant components 119 and/or shared with other components, such as the cloud-based USCD engine 104′ and corresponding cloud-based USCD database 106′, or the cloud-based user interactions engine 108′ and corresponding cloud-based user interactions database 110′.

In various implementations, and with the individual's express permission, user interactions engine(s) 108 may be configured to monitor various types of user interactions between the individual and one or more computing devices 102-1 to 102-N, and store data indicative of relevant interactions in user interactions database 110. In other implementations, USCD engine(s) 104 may handle all functions attributed herein to user interactions engine(s) 108, and user interactions engine(s) 108 may be omitted.

As one example, user interactions engine 108 (or USCD engine 104 in some implementations) may monitor emails, text messages, and/or other forms of electronic content sent or received, e.g., via network 199, by user device 102-1. If the individual receives an email about a flight cancellation, user interactions engine 108 may store data indicative of this email in user interactions database 110. USCD engine 104 may use this data to update the individual's USCD in USCD database 106 to reflect the flight cancellation. Alternatively, USCD engine 104 may monitor emails and update USCD directly, and the user interactions engine 108 may be omitted. The flight cancellation might be used during a subsequent interaction between the individual and a generative model 126. For example, the individual might ask the automated assistant 120 “What is my travel schedule for next week?” The automated assistant 120, using generative model 126, would then be able to provide a more accurate and relevant response, taking into account the flight cancellation.

As another example, user interactions engine 108 (or USCD engine 104 in some implementations) may monitor search engine queries, search engine responses, automated assistant queries, automated assistant responses, and/or other forms of search results received, e.g., via network 199, by user device 102-1. As an example, if an individual searches for vegetarian restaurants, user interactions engine 108 may store data indicative of this query in user interactions database 110. USCD engine 104 may use data indicative of such a search query to update the individual's USCD in USCD database 106 to reflect the user's preference for vegetarian cuisine. The individual's preference for vegetarian cuisine, as it is reflected in the individual's USCD, might be used during a subsequent interaction between the individual and a generative model 126 by providing the individual with restaurant recommendations that are vegetarian-friendly. For example, if the individual asks, “What are some good restaurants near me?”, the generative model 126 could take into account the individual's preference for vegetarian cuisine and recommend restaurants that have a large selection of vegetarian dishes.

As yet another example, user interactions engine 108 (or USCD engine 104 in some implementations) may monitor content consumed, e.g., viewed, listened to, or otherwise experienced by a user device 102-1 to 102-N. For example, if a user watches an online video about a specific topic, user interactions engine 108 may store data indicative of this video in user interactions database 110. This data can then be used to update the user's USCD in USCD database 106 to reflect the user's interest in that topic. As another example, if a user listens to a podcast episode about a specific event, user interactions engine 108 (or USCD engine 104 in some implementations) may store data indicative of this podcast episode in user interactions database 110. USCD engine 104 may use this data to update the user's USCD in USCD database 106 to reflect the user's awareness of that event. If the user later asks the automated assistant 120 “What is the latest news about the event?”, the automated assistant will be able to provide more relevant information based on the user's awareness of the event from the podcast episode.

As yet another example, user interactions engine 108 (or USCD engine 104 in some implementations) may monitor user preferences and/or other user feedback explicitly submitted by the user, e.g., via automated assistant client 118 or otherwise. User preferences that might be captured and incorporated into the USCD include, but are not limited to, preferences for specific types of content (e.g., news, entertainment, music, etc.), preferences for specific topics or genres (e.g., sports, cooking, history, etc.), preferences for specific languages, preferences for specific styles or formats (e.g., formal, informal, casual, etc.), preferences for specific levels of detail or complexity, preferences for specific types of responses (e.g., factual, creative, humorous, etc.), preferences for specific sources of information, preferences for specific types of interactions (e.g., text-based, voice-based, visual, etc.), preferences for specific levels of personalization, preferences for specific levels of privacy, preferences for specific types of assistance (e.g., task-oriented, informational, conversational, etc.), preferences for specific time periods or contexts (e.g., work, home, travel, etc.), preferences for specific individuals or groups (e.g., family, friends, colleagues, etc.), and/or preferences for specific locations or settings.

As yet another example, user interactions engine 108 (or USCD engine 104 in some implementations) may monitor changes made to smart appliance configuration(s) by user device(s) 102-1 to 102-N. Suppose a user adds a new smart light to their kitchen. User interactions engine 108 may store data indicative of this change in user interactions database 110. This data can then be used to update the user's USCD in USCD database 106 to reflect the new configuration of the user's smart appliances. The user's new smart light in the kitchen would be reflected in the user's USCD. When the user asks the automated assistant to “turn on all the kitchen lights” the automated assistant will now include the new smart light in its response, turning it on along with the other lights. Changes made to smart appliance configurations can take a variety of different forms, including but not limited to adding, modifying, and/or removing a smart appliance, installing or removing a software application that interacts with the smart appliance (e.g., a security application, a smart home application, a “smart” thermostat application, etc.), modifying and/or adjusting settings and/or parameters of the smart appliance, modifying and/or adjusting settings and/or parameters of the software application that interacts with the smart appliance, etc.

As yet another example, user interactions engine 108 (or USCD engine 104 in some implementations) may monitor locations and/or trajectories of locations accumulated with previous user consent by one or more client devices 102-1 to 102-N. For example, if an individual frequently visits a particular neighborhood, their USCD may include a record of these visits. If the individual later asks the automated assistant 120, “I want to try something new,” the automated assistant could use the individual's location history to suggest locations outside of their usual neighborhood. If the individual later decides to opt out of having their locations tracked, accumulated locations may be deleted from the individual's user interactions database 110. This may trigger implementations described herein to follow mappings from those deleted trajectories to the individual's USCD, where corresponding portion(s) of the USCD can likewise be deleted. Consequently, if the individual later asks the automated assistant 120, “I want to try something new,” the individual's past travels will no longer be accounted for in the generative model response.

Alternatively, the individual may issue a generative model request, e.g., via automated assistant client 118, to remove one or more trajectories of locations. This may trigger techniques described herein to not only remove corresponding portions from the individual's USCD but, if applicable, to also follow mappings to underlying data sources and make similar changes. Suppose the individual wishes to conceal their presence in a particular neighborhood known for jewelry stores because the individual doesn't wish to leave their partner any clues that the individual has been jewelry shopping. The individual may issue the command, “forget that I've spent time in <hypothetical> neighborhood.” Data indicative of the relevant travel trajectories may be removed from both the individual's USCD and, using the mappings associated with the individual's USCD, the underlying travel trajectories (e.g., stored in association with a fitness application). More generally, an individual may issue a generative model request that removes any type of data from other original sources.

Similar to USCD engine 104, in various implementations, user interactions engine 108 may be required to solicit explicit and/or implicit permission from an individual prior to monitoring user interaction(s) between the individual and computing devices 102-1 to 102-N and storing data indicative thereof in user interactions database 110. For example, user interactions engine 108 may cause client device 102-1 to audibly and/or visually prompt the individual to expressly indicate their willingness to have data provided as user interaction(s) by user interactions engine 108 be stored in user interactions database 110. By being able to opt in and/or out of such use of their personal data, the individual's privacy and/or security in using such data is maintained. In some implementations, an individual's user interaction(s) may be stored only in local user interactions database 110, or may be encrypted before being transmitted to GM-powered automated assistant components 119 and/or shared with other components.

GM-powered automated assistant component(s) 119 may include a TTS component 116, an STT component 117, a prompt assembly engine 122, a GM selection engine 124, a classifier 125, a GM output generator 128, a cloud-based USCD engine 104′ and corresponding database 106′, and a cloud-based user interactions engine 108′ and corresponding user interactions database 110′. TTS component 116 may be configured to leverage the virtually limitless resources of the cloud computing system to convert textual data (e.g., natural language responses formulated by automated assistant 120) into computer generated speech output. In some implementations, TTS component 116 may provide the computer generated speech output to client device 102 to be output directly, e.g., using one or more speakers. TTS component 116 may use any appropriate speech synthesis technique to generate computer generated speech output from textual data including, but not limited to, concatenative synthesis, unit selection synthesis, diphone synthesis, domain-specific synthesis, formant synthesis, Hidden Markov Model (HMM)-based synthesis (e.g., Gaussian mixture core network synthesis), sinewave synthesis, or any combination thereof. In some implementations, the TTS component 116 may be implemented using an end-to-end transformer-based architecture.

STT component 117 may be configured to convert a spoken utterance into text data. In some implementations, STT component 117 may convert an utterance into multiple text segments, e.g., phonemes, word pieces, etc., that are string of characters corresponding to the utterance. STT component 117 may convert the utterance into text data using various speech recognition techniques, such as hidden Markov model (HMM) techniques, dynamic time warping (DTW)-based techniques, neural network-based techniques, or other techniques. In some implementations, the STT component 117 may be implemented using an end-to-end transformer-based architecture.

Prompt assembly engine 122 may be configured to assemble generative model prompts (or “context”) that can then be used by GM selection engine 124 to select one or more GMs from GM database 126, and that can be used by GM output generator 128 to generate generative model output. Prompt assembly engine 122 may assemble generative model prompts from various data sources, such as a user's explicit or implicit generative model query. An explicit generative model query may be issued via the user typing or speaking the query. An implicit generative model query may be issued automatically, e.g., in response to various events that may occur in a software application, in response to particular sensor data, etc.

In addition to an individual's explicit or implicit generative model query, prompt assembly engine 122 may assemble other data into a generative model prompt. For example, prompt assembly engine 122 may assemble data indicative of the individual's USCD, received from cloud-based USCD engine 104′ or a local USCD engine 104-1 to 104-N into the generative model prompt. In some implementations, a cloud-based USCD engine 104′ may obtain this USCD from database 106-1 of client device 102-1 and may temporarily store it in a cloud-based USCD database 106′. Additionally or alternatively, cloud-based USCD engine 104′ may store individuals' USCD data in cloud-based USCD database 106′ on a long term basis, while taking steps to ensure the privacy and security of the individuals' USCD. In some such implementations, the individuals may be required to provide express permission before their USCD can be stored in cloud-based USCD database 106′. Additionally or alternatively, in some implementations, USCD stored in database 106′ (or locally at 106) may be stored in a form that is not readily interpretable by humans, such as in continuous embedding form, encrypted form, hashed form, etc.

As noted above, GM selection engine 124 may be configured to select one or more generative models 126 that are suitable for generating content responsive to, for instance, an individual's generative model query (or even to a generic search query), to an implicit query, and/or to a request to update an individual's USCD based on new user interaction(s). In some implementations, GM selection engine 124 may utilize a classifier 125 to identify a generative model that is most likely to accurately and efficiently respond to a generative model query provided by automated assistant 120 and an individual that provided the generative model query. Such a classifier may itself be a generative model (e.g., an LLM), or it may be another type of machine learning model that is trained to classify or otherwise generate scores for different available generative models 126. As one example, if an individual's query includes both text and an image (e.g., “modify this image to delete the clouds”), the GM selection engine 124 may select a generative model that is suitable for generating synthetic image data, such as a diffusion model. Additionally or alternatively, GM output generator 128 may include a plurality of generative model agents, each configured to perform different task(s) using different generative models, and the GM selection engine 124 may select the most suitable GM agent.

GM output generator 128 may be configured to process a prompt using one or more generative models selected by GM selection engine 124 from GM database 126 (GM database and generative models themselves will both be interchangeably referenced using 126) to generate content that is responsive to, for instance, a generative model query from automated assistant client 118 at a client device 102, or to an implicit query to update an individual's USCD based on new user interaction(s). To this end, GM output generator 128 may have access to one or more generative models in database 126, and may apply those generative model(s) that are selected by GM selection engine 124.

GM database 126 may include a variety of generative models, such as foundation models, fine-tuned models, and task-specific models. Foundation models may be pretrained on large datasets of various types of data, such as text, code, images, videos, audio, etc. Foundation models can be used for a wide range of tasks. Fine-tuned models are foundation models that have been further trained on a specific dataset, such as a dataset of customer service conversations or a dataset of medical records. Task-specific models are designed for a specific task, such as generating code, translating languages, or writing different kinds of creative content. Generative models can be single-modal or multi-modal. Single-modal models process and generate data of a single type, such as text or images. Multi-modal models process and/or generate data of multiple types, such as text and images, or text and audio. Generative models may or may not be transformer-based, and may be encoder-only, decoder-only, or encoder-decoder. Encoder-only models take an input and produce a representation of that input. Decoder-only models take a representation and produce an output. Encoder-decoder models combine both encoder and decoder components. Some generative models that generate non-textual data may include, for instance, stable diffusion models.

The number of parameters in a generative model can vary significantly depending on the model's complexity and the resources available for its implementation. On a resource-constrained client device like 102, the model may have a smaller number of parameters to optimize performance and reduce memory usage. This is because client devices often have limited processing power and memory compared to cloud servers. In contrast, a generative model implemented on a cloud server like 119 can have a much larger number of parameters due to the availability of extensive computing resources. This allows for more complex models with higher accuracy and capabilities. The choice of parameter size is a trade-off between model performance and resource constraints. For example, on a client device with limited resources, a generative model might have 100 million parameters, while a server-based model could have billions of parameters, enabling more complex and accurate results. Another example is a client device model with 500 million parameters, compared to a server model with 100 billion parameters, showcasing the significant difference in scale and capabilities.

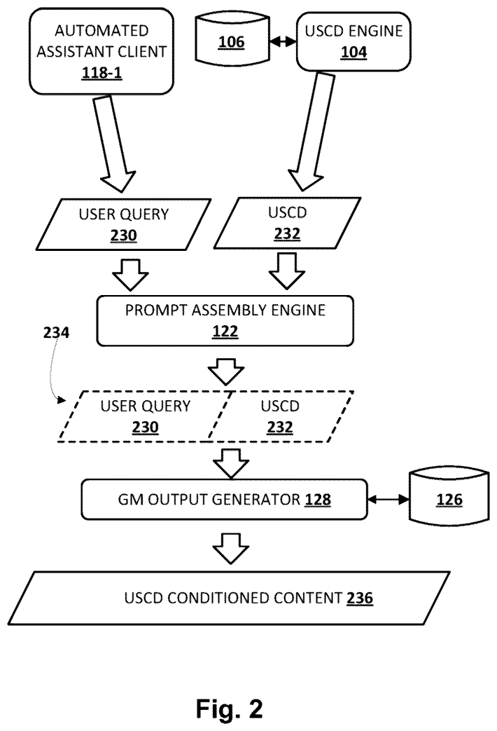

FIG. 2 schematically depicts an example of how various components of FIG. 1 may cooperate to conduct selected aspects of the present disclosure. Beginning at top, USCD engine(s) 104 and automated assistant client 118-1 of client device 102-1 may provide, respectively, data indicative of a user-specific conditioning data (USCD) 232 and a user query 230 to prompt assembly engine 122. Prompt assembly engine 122 may then assemble the USCD 232 and the user query 230 into a generative model prompt 234. While not shown in FIG. 2 for the sakes of brevity and simplicity, this generative model prompt 234 may be provided to GM selection engine 124, and GM selection engine 124 may select appropriate generative model(s) 126 and/or GM agents for processing this generative model prompt 234.

Various other information may or may not be assembled into generative model prompt 234 by prompt assembly engine 122. This other information may, for instance, identify tools (e.g., installed applications, web applications (RESTful or RPC)) that are available to perform various functions (e.g., controlling smart appliances at a home or in a vehicle). Additionally or alternatively, this other information may include system instructions (e.g., not provided by the user) on how USCD should be used to personalize or otherwise condition the generative model output. For instance, the system instructions may include a natural language statement such as “When responding to the user's query, make sure to take into account this summary of the user, including the user's preferences, attributes, etc.” In some implementations, the system instructions may include additional requests designed to avoid various negative outcomes. For example, the system instructions may include a request such as “Medical data of the user should not be disclosed to anyone other than the user. Accordingly, don't directly incorporate the user's medical data into your response. At most, allow the user's medical data to influence other output you generate, without explicitly mentioning the medical data itself.”

Referring back to FIG. 2, prompt assembly engine 122 (or GM selection engine 124) may provide generative model prompt 234 to GM output generator 128. GM output generator 128 may then input the generative model prompt 234 into one or more generative models of GM database 126 to generate output that includes USCD-conditioned content 236. USCD conditioned content 236 may include content that is both responsive to user query 230 and conditioned upon USCD 232.

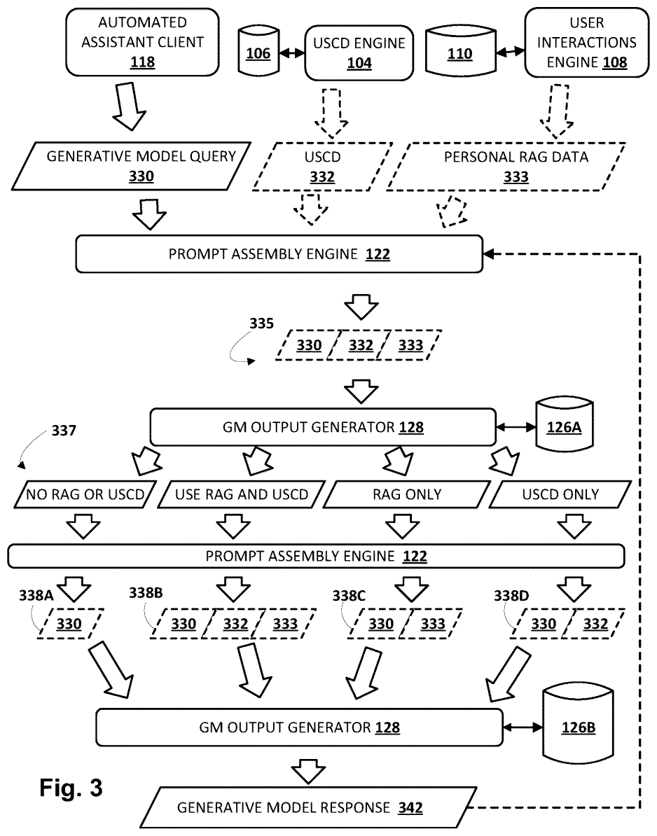

FIG. 3 schematically demonstrates how various components depicted in FIGS. 1 and 2 may cooperate to carry out selected aspects of the present disclosure. Many of the elements of FIG. 3 are similar to those depicted in FIG. 2, and therefore are referenced using similar reference numerals. As is the case with other Figs. described herein, various components of FIG. 3 may be combined, omitted, and may be implemented wholly or partially at the edge (e.g., 120) or at a server (e.g., 119).

Starting at top, automated assistant client 118 (e.g., operating on client device 102) may provide a generative model query 330 to prompt assembly engine 122. Prompt assembly engine 122 may assemble generative model query 330 into a RAG analysis input prompt 335 (which could be multiple prompts in some implementations, or even direct commands to retrieve data from multiple sources of user interactions such as emails, search history, browsing history, etc.). In some implementations, generative model query 330 may be the only data included in RAG analysis input prompt 335, which may be analyzed to determine whether RAG should be used. In other implementations, however, other data may be assembled into RAG analysis input prompt 335 and hence analyzed in conjunction with generative model query 330 to determine whether RAG should be used.

For example, and as indicated by dashed lines, in some implementations, USCD engine 104 (local to client device 102 or cloud based) may or may not provide data indicative of USCD 332 (e.g., the entirety of USCD 332 or metadata describing it) to prompt assembly engine 122. If provided, the data indicative of USCD 332 may be assembled into RAG analysis input prompt 335 along with generative model query 330.

As another example, and as indicated by dashed lines once again, in some implementations, user interactions engine 108 (local to client device 102 or cloud-based) may or may not provide data indicative of what will be referred to herein as personal Retrieval Augmented Generation (RAG) data 333 to prompt assembly engine 122. Personal RAG data 333 may include various data indicative of user interactions accumulated by user interactions engine 108, such as the raw data itself and/or metadata that describes the user interactions. As non-limiting examples, the personal RAG data 333 may include electronic correspondence, documents, software applications, application changes, application setting changes, device configuration changes, security or privacy configuration changes, digital images, content purchases, explicitly provided preferences, rejections of generative model output, social media posts, location trajectories, and/or physiological sensor readings, to name a few. Other examples of user interactions that could be used as personal RAG data 333 are described in the summary. In some cases, user interactions engine 108 may provide data indicative of the aforementioned user interactions timeline stored in database 110 as personal RAG data 333. If provided, all or part of the personal RAG data 333 (e.g., only personal RAG data that was created or modified in the last three months, two weeks, etc.) may be assembled into RAG analysis input prompt 335 along with generative model query 330 (and USCD 332 if present).

RAG analysis input prompt 335 may then be (in some cases after being used by GM selection engine 124 to select an appropriate generative model) provided to GM output generator 128. In some implementations, including that depicted in FIG. 3, GM output generator 128 may use a first generative model 126A to process RAG analysis input prompt 335 to generate RAG analysis output 337 that is indicative of how and/or whether RAG and/or USCD should be used downstream to process generative model query 330. In FIG. 3, RAG analysis output 337 may include one of four options (these are illustrative only and not meant to be limiting): use no RAG or USCD; use both RAG and USCD; use RAG only; or use USCD only. Additionally or alternatively, in some implementations, RAG analysis output 337 may include instructions and/or queries that are operable to retrieve specific personal RAG data that is responsive to aspect(s) of generative model query 330. These instructions/queries may be implemented (e.g., executed, issued) to obtain the relevant raw data (e.g., documents, emails, browsing histories, etc.) for surfacing to the individual directly, and/or for incorporation into downstream generative model prompt(s).

The first option (no RAG or USCD) may be applicable where, for instance, generative model query 330 is answerable without the need of RAG or USCD. For example, a simple query that has nothing to do with an individual, such as “Tell me a joke”, may be answerable endogenously using a generative model's own parameters, and thus warrant neither personal RAG data 333 nor USCD 332. Omitting both USCD 332 and personal RAG data 333 from a downstream generative model input prompt (338A-D in FIG. 3, 234 in FIG. 2) may shorten the context considerably, which in turn may significantly decrease the amount of computing resources used and/or decrease latency.

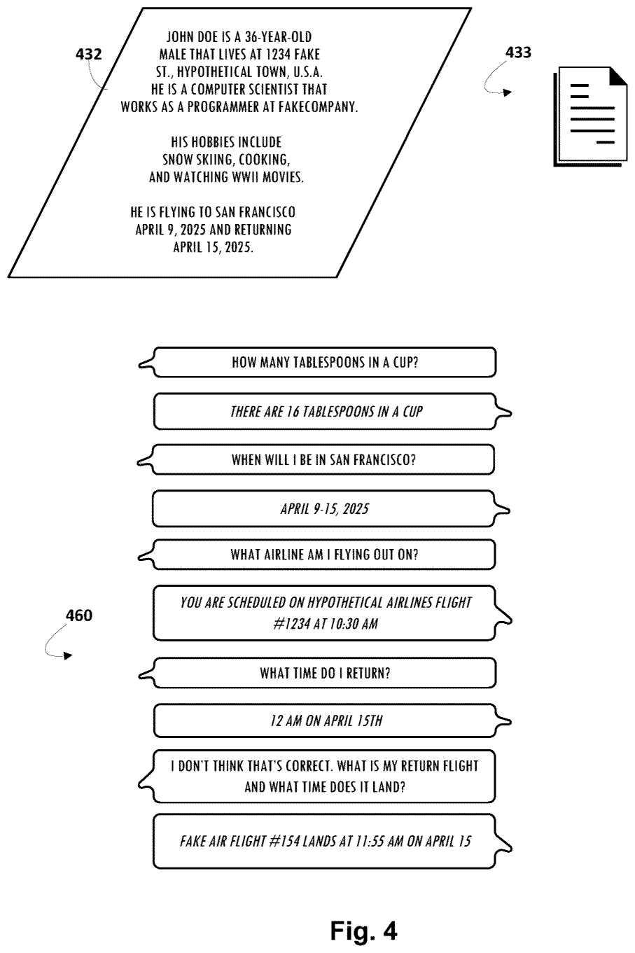

The second option (RAG plus USCD) may be applicable where, for instance, generative model query 330 is best answered using both USCD 332 and personal RAG data 333. For example, a request for information related to an individual that seeks at least some information that is more specific than that contained in USCD 332, but that also would benefit from information contained in USCD 332, may warrant inclusion in a downstream input prompt of both USCD 332 and personal RAG data 333. FIG. 4 provides an example of such a scenario.

The third option (RAG only) may be applicable where, for instance, generative model query 330 is best answered using only RAG and not USCD. This may occur where, for instance, generative model query 330 involves a request for information that is more specific than that in USCD 332, and would not necessarily benefit from information contained in USCD 332. For instance, if no individual datum in USCD 332 is responsive to generative model query 330 but personal RAG data 333 could at least potentially contain data that is responsive to generative model query 330, then it may be slightly advantageous to only include only personal RAG data 333, not USCD 332, in a downstream input prompt to shorten its context length, and hence, decrease the amount of computing resources used and/or decrease latency.

The fourth option (USCD only) may be applicable where, for instance, generative model query 330 is sufficiently answered using exclusively USCD 332, and there is no need for additional information that might be obtained using RAG. For example, if a complete response to generative model query 330 can be generated using USCD 332 exclusively (e.g., with or without the endogenous knowledge parameterized into the generative model), there is no need to include personal RAG data 333. Because USCD 332 is essentially a distilled version and/or summary of the user derived from user interactions accumulated by user interactions engine 108, personal RAG data 333 is likely going to be considerably larger than USCD 332. For example, USCD 332 may include a textual summary and/or embeddings that succinctly represent salient attributes of the user, and may not include every detail of the underlying user interactions that were used to generate USCD 332. By contrast, personal RAG data 333 may include the underlying user interactions in raw form, e.g., whole emails (e.g., filtered based on generative model query 330), consumed documents, entire browsing histories (or at least browsing history over some predetermined time interval), etc. As context windows of generative models grow, it becomes increasingly feasible to include personal RAG data 333 in the generative model prompt. Nonetheless, increasing the context to such an extent can increase computational costs and/or latency considerably, and so refraining from including personal RAG data 333 where possible may remain beneficial to the user experience.

Based on the option included in the RAG analysis output 337 generated by GM output generator 128 using RAG analysis input prompt 335, prompt assembly engine 122 may assemble various other data into the appropriate downstream context. For example, if the option is no RAG or USCD, then prompt assembly engine 122 may assemble a first generative model input 338A that includes data indicative of generative model query 330, without USCD 332 or personal RAG data 333. If the option is both RAG and USCD, then prompt assembly engine 122 may assemble a second generative model input 338B that includes data indicative of generative model query 330, USCD 332, and personal RAG data 333. If the option is RAG only, without USCD, then prompt assembly engine 122 may assemble a third generative model input 338C that includes data indicative of generative model query 330 and personal RAG data 333. If the option is USCD only, then prompt assembly engine 122 may assemble a fourth generative model input 338D that includes data indicative of generative model query 330 and USCD 332.

While not depicted in FIG. 3, in some implementations, GM selection engine 124 may select an appropriate generative model 126B (and/or corresponding GM agent) for processing the generative model prompt 338A, 338B, 338C, or 338D. Using the selected generative model 126B, GM output generator 128 may then generate generative model output 342. In various implementations, and depending on which generative model prompt (338A, 338B, 338C, or 338D) was assembled, some or all of generative model output 342 may be conditioned upon USCD 332 and/or personal RAG data 333. In some implementations in which generative model output 342 is conditioned on personal RAG data 333, attribution may be provided, e.g., in the form of a link (e.g., built using one of the mappings between USCD and user interactions described elsewhere herein) from a relevant portion of generative model output 342 to the underlying user interactions that were retrieved as part of the RAG process. In other implementations, attention scores and/or another machine learning model (applied post hoc) may be used to determine and present attributions for personal RAG data 333.

In some implementations, first generative model 126A selected by GM selection module 126 to process RAG analysis input prompt 335 may have fewer parameters than second generative model 126B, and may be implemented at the edge (e.g., on client device 102). This may enable first generative model 126A to be applied more efficiently and/or with less latency than second generative model 126B. In various implementations, first generative model 126A may be trained as a “student” with second generative model 126B being the “teacher.” For example, the same input prompts may be processed using both models in parallel. The output of the larger teacher model 126B may be used as supervised training data for the smaller student model 126A.

In some implementations, and as indicated by the dashed arrow, various aspects of the process of FIG. 3 may operate as a loop that iteratively adds additional information to the generative model input prompt 338 until the generative model query 330 is adequately addressed. In some implementations, GM output generator 128 may first generate output based on generative model query 330, with USCD 332 (338D) or without using USCD 332 (338A), and without using personal RAG data 333. The generative model response 342 to this first generative model prompt, unconditioned personal RAG data 333, may then be fed back to prompt assembly engine 122 to be assembled into a next RAG analysis input prompt 335. GM output generator 128 may then process this RAG analysis input prompt 335 using generative model(s) (e.g., 126A or 126B) to determine whether personal RAG data 333 (or USCD if not already used) is needed. For example, RAG analysis input prompt 335 may be assembled with generative model query 330 and generative model response 342, along with a system request such as “does this model output fully respond to the model input?” or “could this model output be improved if the model input were augmented with RAG and the user's past interactions?” Based on the option indicated in RAG analysis output 337, the process may continue as depicted in FIG. 3. In other implementations,

FIG. 4 schematically depicts an example of how USCD 432 associated with an individual named John Doe may be used, alone and in combination with personal RAG data of John Doe, to practice selected aspects of the present disclosure. In this example, USCD 432 takes the form of a textual summary of John Doe, but this is not meant to be limiting. In other implementations, USCD 432 may take the form of one or more embeddings that represent attributes of John Doe. In yet other implementations, USCD 432 may be formulated using other modalities of data, such as images (e.g., photographs, synthetic images, bar codes or QR codes, etc.), audio waveforms (e.g., of speech describing John Doe), or any combination of these various modalities of data.

In this example, John Doe is described as a 36-year old male that lives in Hypothetical Town, is a computer scientist that works as a programmer at FakeCompany, likes snow skiing, cooking, and watching WWII movies, and will be in San Francisco from Apr. 9 to Apr. 15, 2025. Also depicted are emails 433 that may be used as John Doe's personal RAG data (e.g., 333 in FIG. 3), and that may include airline emails with details about John Doe's flights to and from San Francisco (notably, details beyond the general travel dates are not included in USCD 432 in this example). While only emails 433 are depicted in FIG. 4, this is for illustrative purposes only. It should be understood that realistically, there was far more personal RAG data (e.g., user interactions represented in raw form and/or formulated as a timeline stored in database 110) of John Doe available.

A multi-turn dialog 460 between John Doe and a generative model-powered automated assistant (e.g., 120) is depicted at bottom of FIG. 4. This dialog 460 depicts examples of where USCD 432 and/or John Doe's personal RAG (in this example, emails 433) can be used selectively to answer various queries. Initially, Doc asks, “how many tablespoons in a cup?” The automated assistant 120 is able to answer this query endogenously without any knowledge beyond that parameterized into an underlying generative model (not depicted in FIG. 4, e.g., 126B), and responds, “There are 16 tablespoons in a cup.”

Next, John Doe asks, “when will I be in San Francisco?” The generative model will not be parameterized/trained using John Doe's personal RAG (e.g., emails 433) due to privacy concerns. Accordingly, when the generative model query “when will I be in San Francisco?” is assembled into a RAG analysis input prompt (e.g., 335 in FIG. 3) and processed by GM output generator 128, the resulting RAG analysis output (337 in FIG. 3) may indicate that (i) USCD 432 should be used to answer this query, and (ii) that because USCD 432 itself has sufficient information to fully answer the query, John Doe's personal RAG data (e.g., emails 433) are not necessary. Consequently, prompt assembly engine 122 may assemble a generative input prompt (e.g., 338D in FIG. 3) that includes the query and USCD 432. The resulting generative model output (e.g., 342 in FIG. 3) is contained in the response from automated assistant 120: “Apr. 9-15, 2025.”

Next, John Doe asks, “what airline am I flying out on?” The specific outgoing airline was not included in the textual summary of USCD 432. Accordingly, when the generative model query “what airline am I flying out on?” is assembled into a RAG analysis input prompt (e.g., 335 in FIG. 3) and processed by GM output generator 128, the resulting RAG analysis output (337 in FIG. 3) may indicate that because USCD 432 lacks any information responsive to the query, John Doc's personal RAG data (e.g., emails 433) should be used instead of (or in addition to) USCD 432. Consequently, prompt assembly engine 122 may assemble a generative input prompt (e.g., 338C in FIG. 3) that includes the query and emails 433. The resulting generative model output (e.g., 342 in FIG. 3) is contained in the response from automated assistant 120: “You are scheduled on Hypothetical Airlines flight #1234 at 10:30 AM.”

An individual's RAG could potentially encompass a massive amount of data, e.g., including all the documents such as emails, webpages, videos, images, etc., that the individual has ever engaged with, or at least engaged with in the last year, six months, six weeks, etc. Consequently, incorporating all of this data into an input prompt may increase the computational costs and/or latency unacceptably. Accordingly, in some implementations, the individual's USCD may be leveraged to reduce the search space of the individual's personal RAG data to a manageable degree. Put another way, in FIG. 4, USCD 432 may be leveraged to selectively retrieve a subset of John Doe's entire personal RAG data.

Thus, for instance, when John Doe asks, “what airline am I flying out on?”, the first input prompt may include his USCD 432 and the resulting first generative model output may be conditioned based on the relevant portion of USCD 432 to identify “April 9” as his general departure date. This generative model output (e.g., 342 in FIG. 3) may then be assembled by prompt assembly engine 122 into a new RAG analysis input prompt, as indicated by the dashed arrow in FIG. 3, to determine what additional information is needed. In some implementations, the resulting RAG analysis output 337 may include one or more retrieval queries or other instructions for accessing data sources such as emails 433 to seck additional information about what flight John Doe will be taking on April 9. In some implementations, the relevant information may be extracted and surfaced to John Doe directly, e.g., without another pass through the generative model. In other implementations, the relevant emails 433 may be assembled as targeted personal RAG data of John Doe that is assembled into the next generative model prompt, and that is processed by GM output generator 128 to generate the more detailed response, “You are scheduled on Hypothetical Airlines flight #1234 at 10:30 AM.”

Turning back to FIG. 4, John Doe next asks, “what time do I return?” While a specific arrival time is not contained in USCD 432, USCD 432 does in fact include a return date (April 15), which could potentially be interpreted as a specific time (e.g., 12 AM on April 15th). Accordingly, when the generative model query “what time do I return?” is assembled into a RAG analysis input prompt (e.g., 335 in FIG. 3) and processed by GM output generator 128, it is possible the resulting RAG analysis output (337 in FIG. 3) may incorrectly indicate that USCD 432 will suffice to answer this query. Consequently, the automated assistant responds, “12 AM on April 15th.”

Knowing this is incorrect, John Doe then issues a follow up query, “I don't think that's correct, what is my return flight and what time does it land?” This follow up query, when assembled as part of a RAG analysis input prompt and processed by GM output generator 128 using generative model (e.g., 126A in FIG. 3), may result in update RAG analysis output indicating that RAG will be necessary. Consequently, John Doe's follow up query may be assembled by prompt assembly engine 122 into a new generative model input prompt with email(s) 433. When this new generative model input prompt is processed by GM output generator 128 using a generative model (e.g., 126B), the result is the automated assistant output, “Fake Air flight #154 lands at 11:55 AM on April 15.” In some implementations, the machine learning model(s) used to process the RAG analysis input prompt, such as generative model 126A, may be trained and/or fine-tuned (e.g., using techniques such as gradient descent, cross entropy, etc.) to be better able to predict that RAG would be needed under similar circumstances moving forward.

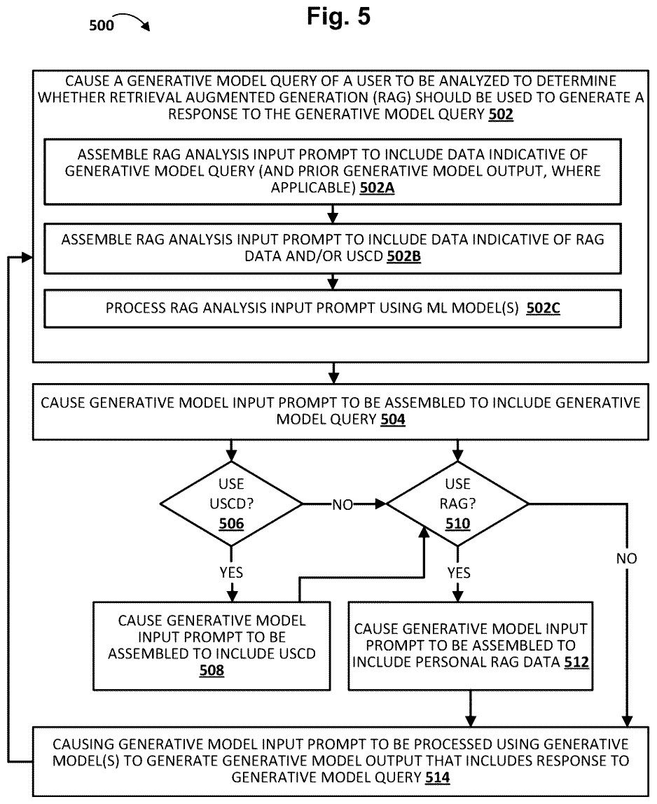

FIG. 5 illustrates a flowchart demonstrating an example method 500 for practicing selected aspects of the present disclosure. For convenience, operations of the flowchart 500 are described with reference to a system of one or more computers that performs the operations. The operations of the flowchart 500 do not necessarily need to be performed in the order shown. Some operations may be performed in parallel, or may be omitted.

At block 502, the system causes a generative model query from a user to be analyzed to determine whether RAG should be used. As shown by blocks 502A-C, in some implementations, this analysis may include, at block 502A, the prompt assembly engine 122 assembling the generative model query into a RAG analysis input prompt (e.g., 335 in FIG. 3). As noted above with FIG. 3, in some implementations, method 500 may be an iterative loop in which USCD and/or RAG may be selectively added during each given iteration, depending on whether the last generative model output sufficiently responded to the original generative model query. Accordingly, in some implementations, if a prior generative model output has already been generated, it may be included in the TAG analysis input prompt at block 502A. In some such implementations, a system query such as “does this generative model output fully satisfy the generative model query” or something to that effect may also be included in the RAG analysis input prompt at block 502.

In some implementations, the RAG analysis input prompt may also be assembled at block 502B to include data indicative of one or both of USCD (e.g., 332 in FIG. 3) or personal RAG data (e.g., 333 in FIG. 3). There may be a desire to perform RAG analysis quickly (to decrease the latency experienced by users and/or to decrease computational costs). Accordingly, the data indicative of USCD and/or personal RAG data 332, 333 that is assembled into the RAG analysis input prompt at block 502B may be limited. For example, the USCD and/or personal RAG data assembled into the RAG analysis input prompt at block 502A may be limited to, for example, some number or amount of most recently (e.g., immediately) accessed documents (e.g., emails 433 of FIG. 4), to metadata that describes USCD and/or personal RAG data at a high level of abstraction (e.g., via reduced dimensionality embeddings), etc. At block 502C, the system, e.g., by way of GM output generator 128, may use a first generative model (e.g., 126A) to process the RAG analysis input prompt to generate RAG analysis output (e.g., 337 in FIG. 3) that indicates whether RAG and/or USCD should be assembled into a downstream generative model input prompt along with the generative model query from the user.

At block 504, the system, e.g., by way of prompt assembly engine 122, may assemble a generative model input prompt (e.g., any of 338A-D) that includes data indicative of the generative model query (e.g., 330). Method 500 next proceeds to block 506, at which point it is determined, e.g., based on the outcome of block 502, whether the individual's USCD should be included in the generative model input prompt 338. If the answer is yes, then method 500 proceeds to block 508. At block 508, the system, e.g., by way of prompt assembly engine 122, assembles all or part of the individual's USCD into the generative model input prompt (which at this point would yield input prompt 338D).

Regardless of whether the answer at block 506 is yes or no, method 500 may proceed to block 510. At block 510, the system determines, e.g., based on the outcome of block 502, whether the individual's personal RAG data (e.g., 333 in FIG. 3) should be included in downstream input prompt. If the answer is yes, then method 500 proceeds to block 512. At block 512, the system, e.g., by way of prompt assembly engine 122, assembles all or part of the individual's personal RAG data (e.g., 333) into the downstream generative model input prompt (yielding either prompt 338C or, if USCD 332 is present, prompt 338B).

Regardless of whether the answer at block 510 is yes or no, method 500 may proceed to block 514. At block 514, the system, e.g., by way of GM output generator 128, may process the generative model input prompt using one or more generative models (e.g., 126B) to generate generative model output (e.g., 342) that includes a response to the generative model query. If present, this response may be conditioned on the USCD and/or the personal RAG data. As shown by the arrow, in some implementations, method 500 may proceed back to block 502, and the analysis may repeat, except this time including the generative model response (e.g., 342) in the RAG analysis input prompt at block 502A.

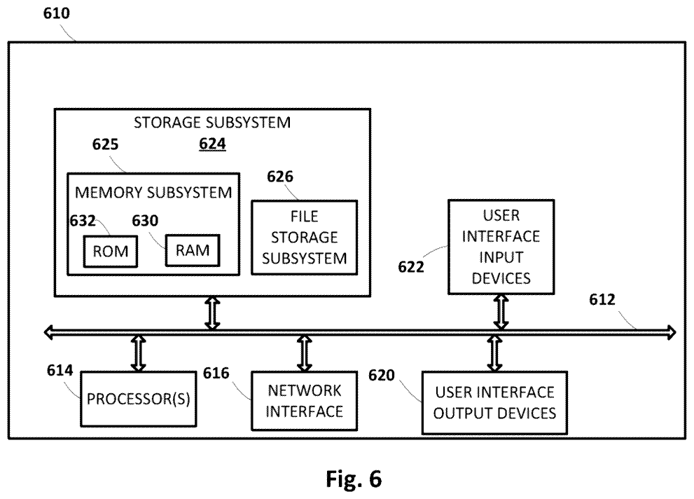

FIG. 6 is a block diagram of an example computer system 610. Computer system 610 typically includes processor(s) 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, user interface input devices 622 may include any device for inputting information into computer system 610.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, user interface output devices 620 may include any device for outputting information from computer system 610 to the user or to another machine or computer system.

Storage subsystem 624 stores programming and data constructs that provide the functionality of some or all of the modules described herein. For example, the storage subsystem 624 may include the logic to perform selected aspects of the method of FIG. 5. These software modules are generally executed by processor(s) 614 alone or in combination with other processors. Processor(s) 614 may take various forms, such as a central processing unit (CPU), a graphics processing unit (GPU), a tensor processing unit (TPU), a neural processing unit (NPU), and so forth.

Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual's discretion.

In various implementations, a method is provided for analyzing a generative model query from a user to determine whether retrieval augmented generation (RAG) should be used to generate a response. If RAG is determined to be necessary, data indicative of the query, user-specific conditioning data (USCD), and personal RAG data, comprising past user interactions, are assembled into a generative model input prompt. The USCD may be built over time based at least in part on the personal RAG data. The prompt is then processed using one or more generative models to generate output conditioned on the USCD and/or personal RAG data.

In some implementations, the generative model query may be processed using one or more machine learning models trained to predict whether RAG should be used. The output from these models may indicate whether USCD or personal RAG data should be included in the input prompt. In some implementations, the same or different generative models may be used to process the query and the input prompt; a first model with fewer parameters may process the query, and a second model may process the input prompt.

In some implementations, first generative model may be used to process the generative model query, and a second generative model, different from the first, may be used to process the generative model input prompt. The first generative model may have fewer parameters than the second generative model. In some implementations, the first generative model may be a student model and the second generative model a teacher model. Alternatively, the same generative model may be used to process both the query and the input prompt. A RAG analysis input prompt, including data indicative of the generative model query, may be assembled, and one or more generative models may be used to process it to generate output indicating whether RAG should be used. This RAG analysis input prompt may further include the USCD and/or past user interactions. If RAG is not needed, the USCD and personal RAG data may be omitted from the generative model prompt.

In various implementations, the USCD may take the form of a textual or embedding-based summary of the user, generated using the personal RAG data. User interactions may include, among other things, electronic correspondence, accessed documents, installed software, software application changes, software application setting changes, device configuration changes, security or privacy configuration changes, digital images, content purchases, explicitly provided preferences, rejections of generative model output, social media posts, location trajectories, and/or physiological sensor readings. New user interactions may include commissioning, altering, or decommissioning smart appliances. In some implementations, the analysis of the generative model query may be performed at a resource-constrained edge device.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
causing a generative model query of a user to be analyzed to determine whether retrieval augmented generation (RAG) should be used to generate a response to the generative model query;
in response to a determination that RAG should be used, causing to be assembled, into a generative model input prompt, data indicative of the generative model query, as well as data indicative of one or both of:
(i) user-specific conditioning data associated with the user, and
(ii) personal RAG data of the user comprising one or more past user interactions between the user and one or more computing devices, wherein the user-specific conditioning data was built over time based at least in part on the personal RAG data of the user; and
causing the generative model input prompt to be processed using one or more generative models to generate generative model output that comprises the response to the generative model query, and that is conditioned on one or both of the user-specific conditioning data or the personal RAG data of the user.

2. The method of claim 1, wherein the generative model query is processed using one or more machine learning models trained to generate output indicative of whether RAG should be used.

3. The method of claim 2, wherein the output comprises an indication that either the user-specific conditioning data or the personal RAG data of the user should be assembled into the generative model input prompt.

4. The method of claim 2, wherein the one or more machine learning models comprises one or more of the generative models.

5. The method of claim 4, wherein a first generative model is used to process the generative model query and a second generative model different from the first generative model is used to process the generative model input prompt.

6. The method of claim 5, wherein the first generative model has fewer parameters than the second generative model.

7. The method of claim 5, wherein the first generative model is a student model and the second generative model is a teacher model.

8. The method of claim 4, wherein the same generative model is used to process the generative model query and to process the generative model input prompt.

9. The method of claim 4, further comprising causing to be assembled, as a RAG analysis input prompt, data indicative of the generative model query, wherein one or more of the generative models is used to process the RAG analysis input prompt to generate the output indicative of whether RAG should be used.

10. The method of claim 9, wherein the RAG analysis input prompt is further assembled to include the user-specific conditioning data and/or one or more of the past user interactions forming the personal RAG data of the user.

11. The method of claim 1, further comprising, in response to a determination that RAG should not be used, refraining from assembling the data indicative of the user-specific conditioning data or personal RAG data of the user into the generative model prompt.

12. The method of claim 1, wherein the user-specific conditioning data comprises a summary of the user generated using the personal RAG data of the user, and wherein the summary comprises a textual summary or one or more embeddings.

13. The method of claim 1, wherein one or more of the user interactions comprises one or more of:
electronic correspondence sent or received by the user using one or more of the computing devices;
a document accessed by the user using one or more of the computing devices;
a software application installed on one or more of the computing devices and used by the user;
a change to an installed software application on one or more of the computing devices and used by the user;
a change made to a software application settings or functionality on one or more of the computing devices and used by the user;
a change made to a computing device configuration on one or more of the computing devices and used by the user;
a change made to a security or privacy configuration of a resource controlled by the user;
one or more digital images captured or altered by the user;
one or more content purchases by the user;
one or more preferences provided explicitly by the user;
rejection of generative model output provided to the user based on the user-specific conditioning data;
one or more social media posts of the user;
one or more location trajectories accumulated by one or more of the computing devices; or
one or more readings from one or more physiological sensors worn by the user.

14. The method of claim 1, wherein the one or more new user interactions comprise one or more of:
commissioning a new smart appliance into a coordinated ecosystem of smart appliances associated with the user;
altering a configuration of a smart appliance within the coordinated ecosystem; or
decommissioning a smart appliance from the coordinated ecosystem.

15. The method of claim 1, wherein the analysis of the generative model query is performed at a resource-constrained edge device.

16. The method of claim 1, wherein the personal RAG data is retrieved based on the user-specific conditioning data.

17. The method of claim 16, wherein the personal RAG data is retrieved based on:
one or more mappings between the user-specific conditioning data and one or more data sources that store at least a portion of the personal RAG data;
a query generated using one or more of the generative models, wherein the query is generated by conditioning one or more of the generative models using the user-specific conditioning data; or
a semantic similarity search.

18. The method of claim 1, wherein the personal RAG data is limited to user interactions during a predetermined time interval.

19. The method of claim 1, further comprising:
causing data indicative of the response to the generative model query to be analyzed to determine whether RAG should be used to generate an augmented response to the generative model query;
in response to a determination that RAG should be used to generate the augmented response to the generative model response, causing to be assembled, into a new generative model input prompt, data indicative of the generative model response, as well as data indicative of one or both of:
(i) the user-specific conditioning data associated with the user, and
(ii) personal RAG data of the user; and
causing the new generative model input prompt to be processed using one or more of the generative models to generate updated generative model output that comprises the augmented response to the generative model query.

20. A system comprising one or more processors and memory storing instructions that, when executed, cause the one or more processors to:
cause a generative model query of a user to be analyzed to determine whether retrieval augmented generation (RAG) should be used to generate a response to the generative model query;
in response to a determination that RAG should be used, cause to be assembled, into a generative model input prompt, data indicative of the generative model query, as well as data indicative of one or both of:
(i) user-specific conditioning data associated with the user, and
(ii) personal RAG data of the user comprising one or more past user interactions between the user and one or more computing devices, wherein the user-specific conditioning data was built over time based at least in part on the personal RAG data of the user; and
cause the generative model input prompt to be processed using one or more generative models to generate generative model output that comprises the response to the generative model query, and that is conditioned on one or both of the user-specific conditioning data or the personal RAG data of the user.
